(19) United States
(12) Patent Application Publication
(10) Pub. No.: US 2025/0313183 A1
(43) Pub. Date: Oct. 9, 2025

(54) HYDRAULIC ASSEMBLY, HOUSING ASSEMBLY FOR A HYDRAULIC ASSEMBLY, AND METHOD FOR PRODUCING A HOUSING ASSEMBLY

(71) Applicant: Robert Bosch GmbH, Stuttgart (DE)

(72) Inventors: Alex Lopez Gandul, Barcelona (ES); Christian Jammes, Barcelona (ES); Raul Vazquez Lopez, Llica d Amunt (ES); Willi Nagel, Remseck/Hochdorf (DE)

(21) Appl. No.: 18/864,788

(22) PCT Filed: May 25, 2023
(86) PCT No.: PCT/EP2023/064058

§ 371 Date: Nov. 11, 2024

(30) Foreign Application Priority Data
May 30, 2022 (DE) 10 2022 205 439.3

(51) Int. Cl. B60T 13/567; B60T 13/74; F16J 15/10

(52) U.S. Cl. CPC B60T 13/5675; B60T 13/745; F16J 15/106

(57) ABSTRACT

A housing assembly for a hydraulic assembly. The housing assembly includes a housing part at least partially enclosing an internal volume, having a through-opening extending between a housing-part inner face directed toward the internal volume and a housing-part outer face oriented in the opposite direction thereto, a region of the inner face surrounding the through-opening forming a depression; a tension anchor extending with an inner portion in the internal volume of the housing part and protruding through the through-opening, an outer portion of the tension anchor protruding beyond the outer face of the housing part; an anchor nut screwed onto the inner portion of the tension anchor and having a sealing face; and a sealing element arranged in the depression and bearing on the inner portion of the tension anchor, on the region of the inner face surrounding the through-opening, and on the sealing face of the anchor nut.

### FIELD

The present invention relates to a hydraulic assembly, in particular for a hydraulic braking system, a housing assembly for a hydraulic assembly and a method for producing a housing assembly.

### BACKGROUND INFORMATION

Hydraulic braking systems in vehicles typically use brake boosters, such as electromotive brake boosters. The functional principle of such brake boosters is based on the fact that a force applied to an actuating device, such as a pedal, is amplified by a hydraulic pressure generating device, such as a master brake cylinder, being actuated by means of an electric motor via a transmission. Here, as a rule, a linear adjustment of an actuating assembly coupled to the pressure generating device is carried out by the transmission, wherein the actuating assembly is received in a housing part and is mounted so as to be linearly displaceable on at least one tie rod provided in the housing part.

German Patent Application No. DE 10 2020 206 337 A1 describes a hydraulic assembly with a housing assembly and a master brake cylinder as a hydraulic device. The housing assembly comprises a housing part and a tension anchor which extends through an opening in the housing part. The hydraulic device is assembled on an outer side of the housing part, wherein the tension anchor protrudes through a bore in a flange of the hydraulic device. A sealing element for sealing the housing is provided between the flange and an outer face of the housing, in order to seal the opening of the housing part in a liquid-tight manner. On the inner side of the housing, a flat anchor nut is screwed onto the tension anchor in order to fix it. Thus, the anchor nut has a short overall length, such that a long guide face is available on the tension anchor, in order to achieve a sufficient stroke length of an actuating assembly guided on the tension anchor in the case of a limited overall length. If the hydraulic device is removed from the housing assembly, e.g. for maintenance or replacement, the sealing element must be replaced.

### SUMMARY

According to the present invention, a housing assembly, a hydraulic assembly, and a method are provided.

According to a first aspect of the present invention, a housing assembly for a hydraulic assembly is provided. According to an example embodiment of the present invention, the housing assembly comprises a housing part at least partially enclosing an internal volume, having a through-opening which extends between a housing-part inner face directed toward the internal volume and a housing-part outer face oriented in the opposite direction thereto, wherein a region of the inner face surrounding the through-opening forms a depression. The housing assembly further comprises a tension anchor which extends with an inner portion in the internal volume of the housing part and which protrudes through the through-opening, such that an outer portion of the tension anchor protrudes beyond the outer face of the housing part, an anchor nut which is screwed onto the inner portion of the tension anchor and has a sealing face, and a sealing element which is arranged in the depression and bears on the inner portion of the tension anchor, on the region of the inner face surrounding the through-opening, and on the sealing face of the anchor nut.

According to a second aspect of the present invention, a hydraulic assembly, in particular for a hydraulic braking system, is provided. According to an example embodiment of the present invention, the hydraulic assembly comprises a housing assembly according to the first aspect of the present invention and a hydraulic device with a flange on which a bore is formed. The outer portion of the tension anchor extends through the bore of the flange and the hydraulic device is fastened to the housing assembly via the tension anchor.

According to a third aspect of the present invention, a method for producing a housing assembly according to the first aspect of the present invention is provided. According to an example embodiment of the present invention, the method comprises arranging the sealing element in the depression of the housing part, passing the tension anchor through the through-opening of the housing part, screwing the anchor nut to the tension anchor and contacting the sealing element with the sealing face of the anchor nut, the region of the inner face surrounding the through-opening and the inner portion of the tension anchor.

One idea underlying the present invention is to provide the housing component of a housing assembly for a hydraulic assembly with a depression on an inner face in a region surrounding the through-opening and to arrange the sealing element assigned to the tension anchor in the depression. In this way, the sealing element bears on an outer circumferential face of the tension anchor extending through the through-opening, on the inner face of the housing part and on a sealing face of the anchor nut, which is screwed onto the tension anchor in the interior of the housing.

By forming the depression on the inner side of the housing part, the installation space required for the sealing element in the interior of the housing part is reduced. Thus, despite an arrangement of the sealing element in the interior, a stroke length for a component guided on the tension anchor, e.g. a sliding bearing of an actuating assembly of a brake booster, can be extended. At the same time, a hydraulic device assembled on the outer side of the housing part on the tension anchor can be replaced or dismantled and reassembled, without a requiring a replacement of the sealing element. Thus, the sealing element seals the through-opening in a liquid-tight manner, in particular if the hydraulic device is dismantled and reassembled or replaced. Thus, the sealing element is better protected against damage.

Advantageous example embodiments and developments of the present invention are disclosed herein.

According to some example embodiments of the present invention, it can be provided that the through-opening is designed to be circular and the depression comprises a conical portion.

According to some example embodiments of the present invention, it can be provided that the housing part is deformed in the region surrounding the through-opening in such a way that the depression is formed on the inner face and a corresponding elevation is formed on the outer face. The housing part, for example, can comprise a substantially flat, in particular plate-shaped cover portion on which the through-opening is formed, wherein the cover portion is deformed in such a way that the region surrounding the through-opening forms the depression on the inner face and a projection or elevation on the outer face.

For example, the housing part, in particular the cover portion, can be formed from a metal sheet, wherein the depression and the elevation are produced by a press-forming process. Optionally, the housing part can have a constant thickness in the region forming the depression and the elevation. The provision of an elevation in addition to the depression facilitates production and at the same time increases the torsional rigidity of the housing part. Furthermore, a depression surrounding the bore can be formed on the flange of the hydraulic device, e.g. in the form of a phase in which the projection is received.

According to some example embodiments of the present invention, it can be provided that the depression has a depth in a range between 1 mm and 4 mm. In particular, the depression can have a depth in a range between 1.5 mm and 3.5 mm. In this range, a noticeable extension of the stroke available on the tension anchor is achieved, while at the same time the sealing element can have relatively large dimensions, which further improves the sealing effect.

According to some example embodiments of the present invention, it can be provided that the anchor nut comprises an inner bore having an internal thread, which is screwed onto an external thread formed on the inner portion of the tension anchor, wherein the sealing face of the anchor nut extends at least partially spaced apart from an end of the external thread directed toward the outer portion of the tension anchor. Thus, a region of the sealing face of the anchor nut, in which the sealing element bears, is spaced apart from the external thread of the tension anchor. In this way, the sealing element is even better protected against damage and the sealing effect is further improved.

According to some example embodiments of the present invention, it can be provided that the internal thread of the anchor nut has an overlap with the external thread of the tension anchor, in relation to the total thread length of the internal thread, in a range of between 60 percent and 95 percent. This means that the nut is screwed beyond the end of the external thread of the tension anchor, such that the end of the nut directed toward the outer portion of the tension anchor is spaced apart from the end of the external thread. As a result, it is also ensured that the sealing element is not damaged by the external thread of the anchor. At the same time, a relatively large friction face between the threads is achieved in this overlap region, which facilitates an optional anti-twisting feature for the anchor nut.

According to some example embodiments of the present invention, it can be provided that the inner bore protrudes beyond the end of the external thread in the direction of the outer portion of the tension anchor and the sealing face of the anchor nut is formed on the inner bore of the anchor nut. For example, the anchor nut can bear with one end face on the inner face of the housing part and the sealing face provided in the inner bore bears on the sealing element. This facilitates a defined positioning of the anchor nut and thus of the tension anchor relative to the housing part.

According to some embodiments example embodiments, it can be provided that the sealing face of the anchor nut is designed as a phase on the inner bore of the anchor nut. Thus, the angled extension of the sealing face ensures that both a force in the axial direction, i.e. a force along the tension anchor, and a force in the radial direction, i.e. in a direction transverse to the tension anchor, are exerted on the sealing element. Thus, the sealing element is pressed in a further improved manner against the inner face of the housing part and against the outer circumferential face of the tension anchor.

According to some example embodiments of the present invention, it can be provided that the anchor nut is secured against rotation on the tension anchor, in particular by a crimp connection. Accordingly, the method can comprise securing the anchor nut screwed onto the tension anchor against rotation on the tension anchor. For example, the anchor nut can be provided with an external hexagon on its outer circumference, of which at least two, preferably three side faces are plastically pressed in the radial direction, in order to achieve a plastic deformation of at least the internal thread, optionally also the external thread of the tension anchor. This connection, known as crimping, offers the advantage that no additional component needs to be inserted for securing the nut, and at the same time a reliable anti-twisting feature is created. Alternatively, other anti-rotation features can be provided.

According to some example embodiments of the present invention, it can be provided that the sealing element is designed to be annular. For example, the sealing element can be designed as an O-ring.

According to some example embodiments of the present invention, it can be provided that the hydraulic device is designed in the form of a hydraulic pressure generating device. For example, the hydraulic device can be a tandem master cylinder, a plunger or the like.

The present invention is explained below with reference to the figures.

### BRIEF DESCRIPTION OF THE DRAWINGS

FIG. 1 is a schematic sectional view of a hydraulic assembly according to one exemplary embodiment of the present invention.

FIG. 2 is a perspective view of an outer side of a housing part of a housing assembly according to an exemplary embodiment of the present invention.

FIG. 3 is a detailed view of the region marked by the letter X of the hydraulic assembly shown in FIG. 1.

FIG. 4 is a flowchart of a method for producing a housing assembly according to an exemplary embodiment of the present invention.

### DETAILED DESCRIPTION OF EXAMPLE EMBODIMENTS

In the figures, identical reference signs denote identical or functionally identical components, unless stated otherwise.

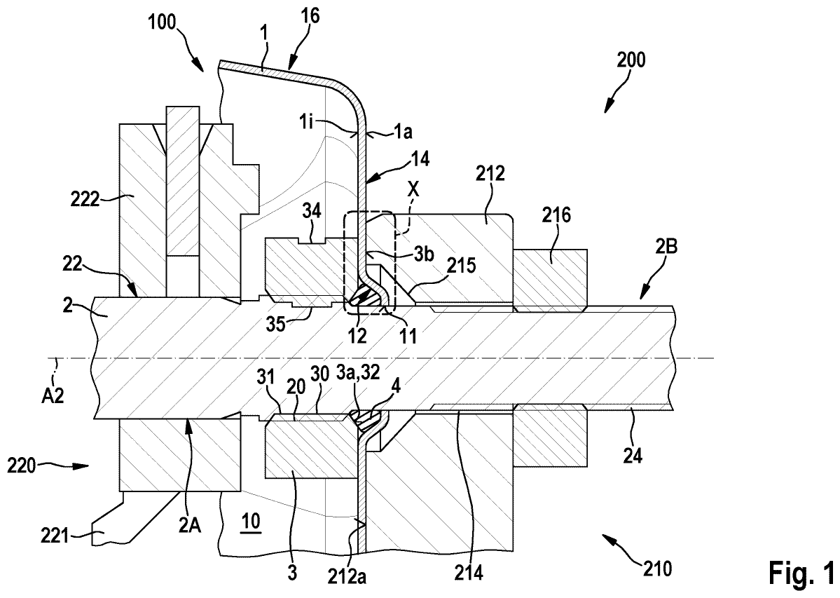

FIG. 1 is a schematic sectional view of a hydraulic assembly 200. The hydraulic assembly 200 comprises a housing assembly 100 and a hydraulic device 210. The hydraulic assembly 200 can be used, for example, as an assembly in an electromotive brake booster for a vehicle or such a brake booster can comprise the hydraulic assembly 200.

The hydraulic device 210 is only partially shown in FIG. 1 and comprises a flange 212 in which at least one bore 214 is formed. The hydraulic device 210 can be, e.g., a hydraulic pressure generating device, such as a master brake cylinder, in particular a tandem master brake cylinder, a plunger or the like. The hydraulic device 210 can be mechanically actuated in particular by means of an actuating assembly 220. The actuating assembly 220 is also only partially shown in FIG. 1 and can, as shown by way of example, comprise, e.g., a connecting arm 221 and a sliding bearing 222 connected to the connecting arm 221. The connecting arm 221 can be linearly displaced by means of an electric motor (not shown), which is kinematically coupled to the actuating assembly, for example via a transmission (not shown), in order to actuate the hydraulic device 210.

As shown in FIG. 1, the housing assembly 100 comprises a housing part 1, a tension anchor 2, an anchor nut 3 and a sealing element 4.

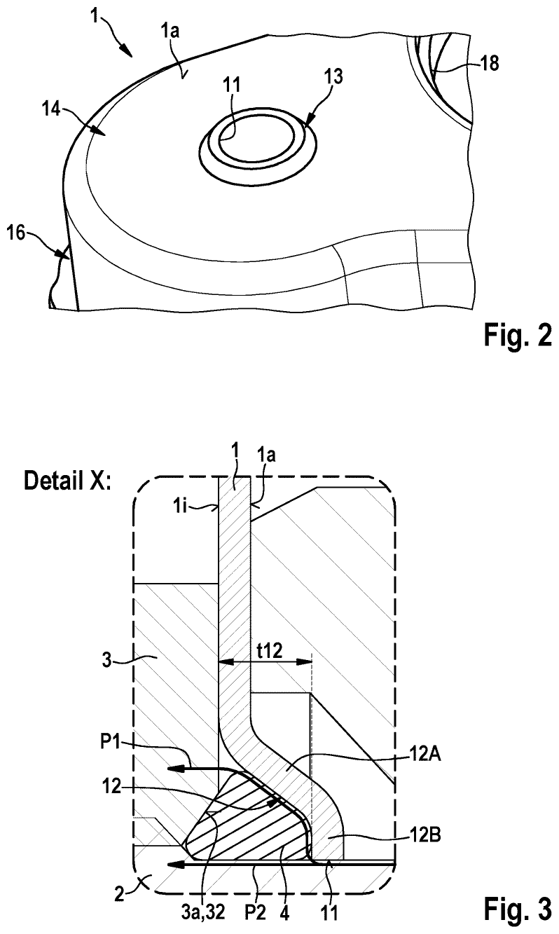

The housing part 1 is only partially shown in FIG. 1. FIG. 2 is a schematic perspective partial view of the housing part 1. In general, the housing part 1 defines or encloses an internal volume 10 at least partially. As shown in FIGS. 1 and 2 by way of example, the housing part 1 can, for example, include a substantially flat or plate-shaped cover portion 14 and a circumferential portion 16 extending transversely thereto. In general, the housing part 1 comprises an inner face 1i directed toward the internal volume 10 or enclosing the internal volume 10 and an outer face 1a oriented opposite thereto. As further shown in FIGS. 1 and 2, the housing part 1 comprises a through-opening 11 which extends between the inner face 1i and the outer face 1a of the housing part 1 and which can be formed in particular in the cover portion 14. The through-opening 11 can in particular comprise a circular circumference. Furthermore, a central connection opening 18 can be formed in the cover portion 14, which extends between the inner face 1i and the outer face 1a of the housing part 1 and serves for receiving an actuation interface of the hydraulic device 210. The housing part 1 can be formed, e.g., from a metal material, in particular a metal sheet. However, the present invention is not limited to this.

As shown in FIG. 1, a region of the inner face 1i surrounding the through-opening 11 forms a depression 12. Thus, the through-opening 11 is provided or arranged on the bottom or base 12B of a depression 12 formed on the inner face 1i. As shown in FIGS. 1 and 3, the depression 12 can comprise a conical portion 12A. The opening angle of the conical portion 12A can, e.g., be in a range between 70 degrees and 90 degrees. Further optionally, the depression 12 can comprise a substantially flat bottom portion 12B, in which the depression 12 is formed. As shown by way of example in FIG. 2, the housing part 1 can further comprise an elevation 13 on the outer face 1a in the region surrounding the through-opening 11. As shown schematically in FIG. 1, the housing part 1 can thus be deformed in such a way that the depression 12 is formed on the inner face 1i and a corresponding, complementary elevation 13 is formed on the outer face 1a. The depression 12 can, for example, have a depth t12 in a range between 1 mm and 4 mm (FIG. 3).

The tension anchor 2 is designed as a rod-shaped, elongated part which extends along a longitudinal axis A2. As shown in FIG. 1, the tension anchor 2 runs in the internal volume 10 and extends through the through-opening 11. A region of the tension anchor 2 located in the internal volume 10 forms an inner portion 2A, a region of the tension anchor 2 defined by the outer face 1a of the housing part 1 forms an outer portion 2B of the tension anchor 2. Thus, the tension anchor 2 extends transversely to the cover portion 14. The outer portion 2B of the tension anchor 2 protrudes beyond the outer face 1a of the housing part 1, in particular the cover portion 14.

As shown in FIG. 1, the inner portion 2A of the tension anchor 2 can comprise an external thread 20 in a region directed toward the through-opening 11. Furthermore, the tension anchor 2 can comprise a guide portion 22 on its inner portion 2A, on which the sliding bearing 222 is guided linearly or displaceably along the longitudinal axis A2. The outer portion 2B of the tension anchor 2 simultaneously forms an end portion of the tension anchor and can optionally also be provided with an external thread 24. As can be seen in FIG. 1, the outer portion 2B can have a smaller diameter, at least in some regions, in particular in the region of the thread 24, than the inner portion 2A in the region of the thread 20.

The anchor nut 3 is designed as a screwable sleeve. Accordingly, the anchor nut 3 comprises an inner bore 30 having an internal thread 31. Furthermore, the anchor nut 3 has a sealing face 3a, which can be provided, e.g., on the inner bore 30. As shown in FIGS. 1 and 3 as an example, the sealing face 3a can be designed, e.g., as a phase 32 on the inner bore 30 of the anchor nut 3. Thus, the phase 32 defines a conical contact face or sealing face 3a, which can, e.g., comprise an opening angle in a range between 100 degrees and 140 degrees. Furthermore, the anchor nut 3 can optionally be provided with an external hexagon on its outer circumference.

As shown schematically in FIG. 1, the anchor nut 3 is screwed onto the external thread 20 of the tension anchor 2 provided on the inner portion 2A. Optionally, the anchor nut 3 can be secured against rotation on the tension anchor 2, in particular by a crimp connection. For this purpose, the outer circumference of the anchor nut 3 can comprise at least one plastic deformation in the form of a notch 34, which causes a plastic deformation 35 on the internal thread 31. As further shown in FIG. 1, the anchor nut 3 bears with an end face 3b on the inner face 1a of the housing part 1.

As further shown in FIG. 1, the outer portion 2B of the tension anchor 2 protrudes through the bore 214 of the flange 212. For fixing the flange 212 to the housing part 1, an external nut 216 can be provided, which is screwed onto the external thread 24 of the outer portion 2B of the tension anchor 2 and clamps the flange 212 between itself and the housing part 1, in particular its cover portion 14. Optionally, the outer nut 216 can also be secured against rotation by a crimp connection to the tension anchor 2. As can also be seen in FIG. 1, the flange 212 can comprise a depression 215 on a contact face 212a directed toward the housing part 1 in a region surrounding the bore 214, in which the optionally made elevation 13 of the housing part 1 is received. However, the depression 215 can also be provided independently of the elevation of the housing part 1.

The sealing element 4 can in particular be designed to be annular, e.g. as an O-ring, as shown by way of example in FIGS. 1 and 3. As shown in FIG. 1, the sealing element 4 is arranged in the depression 12 on the inner face 1i of the housing part 1 and thus surrounds the through-opening 11. Furthermore, the sealing element 4 encloses the inner portion 2A of the tension anchor 2 and is in contact with the sealing face 3a of the anchor nut 3. As can be seen in particular in FIG. 3, the sealing element 4 thus bears in the depression 12 on the inner face 1i of the housing part 1, on the outer circumferential face of the tension anchor 2 and on the sealing face 3a of the anchor nut 3. Thus, the sealing element 4 seals the through-opening 11 in a fluid-tight manner, e.g. against leakage of liquid from the internal volume 10 or against penetration of liquid into the internal volume 10. The sealing element 4 is squeezed or compressed in particular between the sealing face 3a of the anchor nut 3 and the region of the inner face 1i forming the depression 12. In FIG. 3, the sealing paths that the sealing element 4 seals are indicated by the arrows P1, P2.

Due to the arrangement of the sealing element 4 in the depression 12 on the side of the inner face 1i of the housing part 1, the space required by the sealing element 4 in the internal volume 10 in relation to the longitudinal axis L1 is reduced. Thus, the guide portion 22 of the tension anchor 2 can reach relatively close to the inner face 1i of the housing part 1 or to the cover portion 14 in the axial direction.

Effectively, the stroke, i.e. the distance that the sliding bearing 222 can travel on the tension anchor 2, can thus be extended. The arrangement of the sealing element 4 in the depression 12 on the side of the inner face 1i of the housing part 1 offers the further advantage that the sealing element 4 is well protected against external influences. In particular, the hydraulic device 210 can be removed without damaging the sealing element 4 and/or requiring replacement of the sealing element 4 if the hydraulic device 210 is re-flanged or a new hydraulic device 210 is assembled.

As shown by way of example in FIGS. 1 and 3, the anchor nut 3 can be positioned relative to the tension anchor 2 in such a way that the sealing face 3a of the anchor nut 3 extends at least partially spaced apart from an end of the external thread 20 directed toward the outer portion 2B of the tension anchor 2. As can be seen in FIG. 3, e.g., the inner bore 30 of the anchor nut 3 with the sealing face 3a provided thereon, which in this case is conical, can protrude beyond the end of the external thread 20 of the tension anchor 2. As a result, it can be reliably prevented that the sealing element 4 is damaged by the external thread 20.

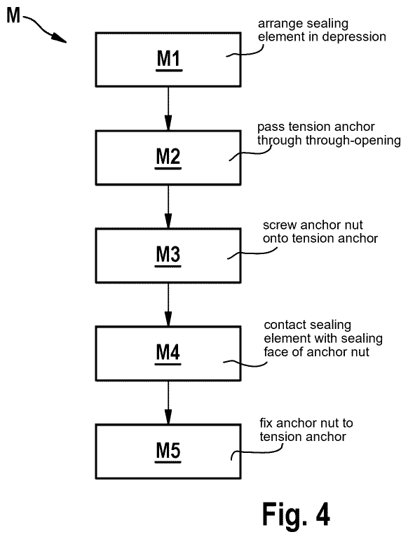

FIG. 4 shows schematically the sequence of a method M for producing a housing assembly 100. The method M is explained below by way of example with reference to the housing assembly 100 described above. The method M comprises arranging M1 the sealing element 4 in the depression 12 of the housing part 1 along with a step M2, in which the tension anchor 2 is passed through the through-opening 11 of the housing part 1, in particular in such a way that the external thread 20 and the guide portion 22 are positioned in the internal volume 10 of the housing part 1. The steps M1 and M2 can be carried out in particular in such a way that the sealing element 4 is pushed onto the tension anchor 2 and is positioned in the depression by passing the tension anchor 2 through the through-opening 11. Alternatively, however, the sealing element 4 can initially be positioned in the depression 12 and the tension anchor 2 can then be pushed through the sealing element 4 in step M2. In a further step M3, the anchor nut 3 is screwed onto the tension anchor 2, as described above. The screwing M2 can take place before or after passing (step M2) the tension anchor 2 through the through-opening 11.

Furthermore, a step M4 takes place for contacting the sealing element 4 with the sealing face 3a of the anchor nut 3, the region of the inner face 1i surrounding the through-opening 11 and the inner portion 2A of the tension anchor 2. The step M4 can take place simultaneously with the execution of the steps M1 to M3. For example, the contacting of the sealing element 4 with the inner portion 2A of the tension anchor 2 can take place during the step M2. The contacting of the sealing element 4 with the sealing face 3a of the anchor nut 3 and the region of the inner face 1i surrounding the through-opening 11 can be carried out, e.g., by the screwing in step M3.

Furthermore, an additional step M5 can optionally be provided, in which the anchor nut 3 is fixed to the tension anchor in a rotationally secure manner, e.g. by crimping.

Although the present invention has been explained above by way of example with reference to exemplary embodiments, it is not limited thereto, but can be modified in many ways. In particular, combinations of the above exemplary embodiments are also possible.

1-10. (canceled)

11. A housing assembly for a hydraulic assembly, comprising:
a housing part which at least partially encloses an internal volume, the housing part having a through-opening which extends between an inner face directed toward the internal volume and an outer face of the housing part oriented in an opposite direction as the inner face, wherein a region of the inner face surrounding the through-opening forms a depression;
a tension anchor which extends with an inner portion in the internal volume of the housing part and which protrudes through the through-opening, such that an outer portion of the tension anchor protrudes beyond the outer face of the housing part;
an anchor nut which is screwed onto the inner portion of the tension anchor and has a sealing face; and
a sealing element which is arranged in the depression and bears on the inner portion of the tension anchor, on the region of the inner face surrounding the through-opening, and on the sealing face of the anchor nut.

12. The housing assembly according to claim 11, wherein the housing part is deformed in the region surrounding the through-opening in such a way that the depression is formed on the inner face and a corresponding elevation is formed on the outer face.

13. The housing assembly according to claim 11, wherein the depression has a depth in a range between 1 mm and 4 mm.

14. The housing assembly according to claim 11, wherein the anchor nut includes an inner bore having an internal thread, which is screwed onto an external thread formed on the inner portion of the tension anchor, wherein the sealing face of the anchor nut extends at least partially spaced apart from an end of the external thread directed toward the outer portion of the tension anchor.

15. The housing assembly according to claim 14, wherein the inner bore protrudes beyond the end of the external thread in a direction of the outer portion of the tension anchor, and the sealing face of the anchor nut is formed on the inner bore of the anchor nut.

16. The housing assembly according to claim 15, wherein the sealing face of the anchor nut is formed as a phase on the inner bore of the anchor nut.

17. The housing assembly according to claim 11, wherein the anchor nut is secured against rotation on the tension anchor by a crimp connection.

18. The housing assembly according to claim 11, wherein the sealing element is an annular O-ring.

19. A hydraulic assembly for a hydraulic braking system, comprising:
a housing assembly, including:
a housing part which at least partially encloses an internal volume, the housing part having a through-opening which extends between an inner face directed toward the internal volume and an outer face of the housing part oriented in an opposite direction as the inner face, wherein a region of the inner face surrounding the through-opening forms a depression,
a tension anchor which extends with an inner portion in the internal volume of the housing part and which protrudes through the through-opening, such that an outer portion of the tension anchor protrudes beyond the outer face of the housing part,
an anchor nut which is screwed onto the inner portion of the tension anchor and has a sealing face, and
a sealing element which is arranged in the depression and bears on the inner portion of the tension anchor, on the region of the inner face surrounding the through-opening, and on the sealing face of the anchor nut;
a hydraulic device including a pressure generating device, the hydraulic device having a flange on which a bore is formed;
wherein the outer portion of the tension anchor protrudes through the bore of the flange, and the hydraulic device is fastened to the housing assembly via the tension anchor.

20. A method for producing a housing assembly, the housing assembly including:
a housing part which at least partially encloses an internal volume, the housing part having a through-opening which extends between an inner face directed toward the internal volume and an outer face of the housing part oriented in an opposite direction as the inner face, wherein a region of the inner face surrounding the through-opening forms a depression,
a tension anchor which extends with an inner portion in the internal volume of the housing part and which protrudes through the through-opening, such that an outer portion of the tension anchor protrudes beyond the outer face of the housing part, an anchor nut which is screwed onto the inner portion of the tension anchor and has a sealing face, and
a sealing element which is arranged in the depression and bears on the inner portion of the tension anchor, on the region of the inner face surrounding the through-opening, and on the sealing face of the anchor nut;
the method comprising the following steps:
arranging the sealing element in the depression of the housing part;
passing the tension anchor through the through-opening of the housing part;
screwing the anchor nut onto the tension anchor; and
contacting the sealing element with the sealing face of the anchor nut, the region of the inner face surrounding the through-opening, and the inner portion of the tension anchor.
